(19) United States
(12) Patent Application Publication
(10) Pub. No.: US 2025/0284648 A1
(43) Pub. Date: Sep. 11, 2025

(54) COUPLER FOR CONNECTING A MASTER TO A SLAVE OF A COMMUNICATIONS NETWORK, AND METHOD FOR OPERATING THE COUPLER

(71) Applicant: Turck Holding GmbH, Halver (DE)

(72) Inventors: Markus Fischer, Zwickau (DE); Jens Köhler, Chemnitz (DE); René Schubert, Chemnitz (DE)

(73) Assignee: Turck Holding GmbH, Halver (DE)

(21) Appl. No.: 19/215,465

(22) Filed: May 22, 2025

Related U.S. Application Data
(63) Continuation of application No. PCT/EP2023/081752, filed on Nov. 14, 2023.

(30) Foreign Application Priority Data
Nov. 24, 2022 (LU) LU503108

(51) Int. Cl. G06F 13/20

(52) U.S. Cl. CPC G06F 13/20; G06F 2213/40

(57) ABSTRACT

A coupler for connects a master to a slave of a communications network, wherein the coupler is designed to receive device data from the master according to a predetermined communications standard, and to output same to the slave according to the predetermined communications standard. The coupler is designed to identify a predetermined control command in the device data and to activate a function stored in the coupler according to the identified control command.

### CROSS REFERENCE TO RELATED APPLICATIONS

This application is a continuation application of international patent application PCT/EP2023/081752, filed on Nov. 14, 2023, and designating the U.S., which claims priority to Luxembourg patent application LU503108, filed on Nov. 24, 2022, each of which are hereby incorporated by reference in their entireties.

### TECHNICAL FIELD

The present disclosure relates to a coupler for connecting a master to a slave of a communications network, a communications network having the coupler, and/or a method for operating the coupler. Additionally or alternatively, a computer program is provided which comprises commands that cause the coupler to carry out the method at least partially when the program is executed. Additionally or alternatively, a computer-readable medium is provided which comprises commands that cause the coupler to carry out the method at least partially when the commands are executed.

### BACKGROUND

The subsequent discussion of the prior art is not to be construed as an admission that this prior art is generally known or is part of general technical knowledge in the technical field underlying the disclosure.

EP 3 944 565 A1 relates to a system for establishing a data connection between a master unit and at least one device unit, wherein the master unit is coupled to a primary coupler unit and the at least one device unit is coupled to a secondary coupler unit in each case for electrical power transmission and for data transmission. The primary coupler unit and the secondary coupler unit are couplable for data transmission. A control signal is receivable and the system has three operating states activatable depending on the received control signal. When the first operating state is activated, a data connection is established between the master unit and the device unit in accordance with the IO-Link standard. When the second operating state is activated, primary coupler identification data are assigned to the primary coupler unit, wherein a data connection is established between the master unit and the primary coupler unit in accordance with the IO-Link standard. When the third operating state is activated, secondary coupler identification data are assigned to the secondary coupler unit, wherein a data connection is established between the master unit and the secondary coupler unit in accordance with the IO-Link standard. The invention further relates to a method for operating the system.

In automation technology, a communications system known under the brand name IO-Link is used to connect intelligent sensors and actuators to an automation system, which is standardized in standard IEC 61131-9 under the name single-drop digital communication interface for small sensors and actuators (SDCI). The standardization comprises both the electrical connection data and a digital communications protocol by means of which the sensors and actuators exchange data with the controller.

An IO-Link system comprises an IO-Link master and one or more IO-Link devices, i.e. sensors or actuators. The IO-Link master acts as a gateway, i.e. it provides the interface to the higher-level controller (PLC) or to the host (processor) and controls the communication between the host and the connected IO-Link devices.

An IO-Link device can be an intelligent sensor, actuator, hub or, due to bidirectional communication, also a mechatronics component, e.g. a gripper or a power supply unit having an IO-Link connection. With regard to IO-Link, the term “intelligent” means that a device has identification data, e.g. a type designation and a serial number or parameter data (e.g. sensitivities, switching delays and/or characteristics) that are readable or writeable via the IO-Link protocol. This means that the PLC can change parameters in some cases during ongoing operation. However, the term “intelligent” also means that the device can provide detailed diagnostic information.

In order to exchange data between an IO-Link device and a PLC or host, the IO-Link data are mapped from the IO-Link master onto the fieldbus that is used. This is referred to as IO-Link mapping onto the fieldbus. If the IO-Link master is directly connected to a PLC via a proprietary backplane bus, the IO-Link data are mapped onto this bus and are transmitted to the PLC or from the PLC to the IO-Link master and on to the IO-Link device. Specifications for IO-Link mapping for PROFIBUS, PROFINET, INTERBUS, AS-i, EtherCAT and Powerlink already exist.

During cyclic data exchange, process data are transmitted from and/or to the IO-Link device via the fieldbus or backplane bus. The parameter data must be explicitly requested by the PLC or must be transmitted flagged as such. The ISDU (indexed service data unit) is defined in the IO-Link specification for this purpose. Parameter values and states can be queried in an IO-Link device using indices and subindices. The requests (read-write services) are encoded in the IO-Link master into an IO-Link-specific ISDU and are transmitted to the IO-Link device via the IO-Link interface. The ISDU specifies whether the request is a read or write request. The indices specify the parameters of which the values are to be read or written.

The IO-Link standard is based on a point-to-point bus topology, so that there is conventionally no way to access a coupler which is connected between an IO-Link master and an IO-Link device and which loops through information or data packets between these two IO-Link components. In other words, the coupler is initially transparent and cannot be activated by conventional means.

### SUMMARY

Provided is a coupler for connecting a master to a slave of a communications network, wherein the coupler comprises a first communication interface and a second communication interface. The coupler is designed to receive device data from the master via the first communications interface in accordance with a predetermined communications standard. The coupler is further designed to detect a predetermined control command in the device data, and call a function stored in the coupler according to the detected control command upon detection of the predetermined control command.

Provided is a communications network, comprising a master, a coupler and a slave connected via the coupler to the master, wherein the coupler is designed to receive device data from the master in accordance with a predetermined communications standard, detect a predetermined control command in the device data, and call a function stored in the coupler according to the detected control command upon detection of the control command.

Provided is a method for operating a coupler for connecting a master to a slave of a communications network, wherein the method comprises receiving device data from the master to the coupler in accordance with a predetermined communications standard, detecting a predetermined control command in the device data by use of the coupler, and calling a function stored in the coupler according to the detected control command by use of the coupler upon detecting the predetermined control command in the device data.

### BRIEF DESCRIPTION OF THE DRAWINGS

An embodiment is described below with reference to FIGS. 1 and 2.

FIG. 1 schematically shows a communications network as disclosed, and

FIG. 2 schematically shows a flow diagram of a method for controlling the communications network.

### DETAILED DESCRIPTION

In the following, details are set forth to provide a more thorough explanation of the disclosure. However, it will be apparent to those skilled in the art that these implementations may be practiced without these specific details. In other instances, well-known structures and devices are shown in block diagram form or in a schematic view rather than in detail in order to avoid obscuring the disclosure. In addition, features described hereinafter may be combined with each other, even if described with respect to different figures, unless specifically noted otherwise.

Equivalent or like elements or elements with equivalent or like functionality are denoted in the following description with equivalent or like reference numerals. As the same or functionally equivalent elements are given the equivalent or like reference numbers in the figures, a repeated description for elements provided with the equivalent or like reference numbers may be omitted. Hence, descriptions provided for elements having the equivalent or like reference numbers are mutually exchangeable.

Directional terminology, such as “top,” “bottom,” “below,” “above,” “front,” “behind,” “back,” “leading,” “trailing,” etc., may be used with reference to the orientation of the figures being described. Because parts of the disclosure, described herein, can be positioned in a number of different orientations, the directional terminology is used for purposes of illustration and is in no way limiting. It is to be understood that other implementations may be utilized, and structural or logical changes may be made without departing from the scope defined by the claims. The following detailed description, therefore, is not to be taken in a limiting sense.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

In implementations described herein or shown in the drawings, any direct electrical connection or coupling, e.g., any connection or coupling without additional intervening elements, may also be implemented by an indirect connection or coupling, e.g., a connection or coupling with one or more additional intervening elements, or vice versa, as long as the general purpose of the connection or coupling, for example, to transmit a certain kind of signal or to transmit a certain kind of information, is essentially maintained. Features from different implementations may be combined to form further implementations. For example, variations or modifications described with respect to one of the implementations may also be applicable to other implementations unless noted to the contrary.

The terms “substantially” and “approximately” may be used herein to account for small manufacturing tolerances (e.g., within 5%) that are deemed acceptable in the industry without departing from the aspects of the implementations described herein. For example, a resistor with an approximate resistance value may practically have a resistance within 5% of that approximate resistance value.

In the present disclosure, expressions including ordinal numbers, such as “first”, “second”, and/or the like, may modify various elements. However, such elements are not limited by the above expressions. For example, the above expressions do not limit the sequence and/or importance of the elements. The above expressions are used merely for the purpose of distinguishing an element from the other elements. For example, a first box and a second box indicate different boxes, although both are boxes. For further example, a first element could be termed a second element, and similarly, a second element could also be termed a first element without departing from the scope of the present disclosure.

A coupler may be provided, wherein the coupler is designed or configured to connect a master to a slave of a communications network. The coupler is designed to receive device data from the master in accordance with a predetermined communications standard (and optionally to output these data to the slave in accordance with the predetermined communications standard). The coupler is designed to detect a predetermined control command in the device data. The coupler is designed to call a function stored in the coupler according to the detected control command.

It is conceivable that the coupler forwards the received device data to the slave only if said device data do not contain the control command. It is also conceivable that the coupler forwards the device data to the slave regardless of whether said device data contain the control command.

A coupler can be understood to mean an electronic component for galvanic isolation and optionally for the isolation protection of signals. The signals can be separated optically by means of optocouplers, but also, additionally or alternatively, by use of a transformer coupler or capacitive coupler, or magnetically using a magnetic coupler. The signals can be used to transmit the data. In other words, the coupler can be used for bi-directional loop-through of data or signals.

The slave can be a field device, e.g. an actuator and/or a sensor. A field device (FD) can be understood to mean a technical facility in the automation technology domain which is directly related to a production process. In automation technology, the term “field” refers to the area outside control cabinets or control rooms. Field devices can therefore be both actuators (manual controllers, valves, etc.) and sensors (measuring transducers) in factory and process automation. The field device can be connected to a control and management system, usually via a fieldbus, or increasingly also via real-time Ethernet. The data received from the field device are evaluated in the control and management system and can be used to regulate and/or control the production process and, additionally or alternatively, for further processing. A state of the production process (e.g. valve opened/closed, pressure, flow rate, temperature, etc.) can be visualized and displayed as part of the further processing, for example.

The master can be a control device which is designed to process data received from the slave via the coupler and/or to output data via the coupler to the slave to control an operation of the slave, and to output data to the coupler to control an operation of the coupler. These data can be the device data, which can be distinguished from the process data described later. The device data can be used to parameterize the coupler and the slave. Additionally or alternatively, the master can be a gateway which is designed to receive data from a control and management system in a further communications standard (e.g. Ethernet) and to output these data to the coupler and the slave in the predetermined communications standard (e.g. IO-Link), and optionally, vice versa, to receive data from the coupler and the slave in the predetermined communications standard and output these data to the control and management system in the further communications standard.

The predefined communications standard can be IO-Link. The slave and the coupler can be configured as IO-Link devices. The slave can therefore be a sensor, actuator, hub, and/or a mechatronics component, e.g. a gripper and/or a power supply unit with an IO-Link connection. The master can be configured as an IO-Link master. As described above, IO-Link is a standardized IO technology (IEC 61131-9) for communicating with IO-Link devices, such as sensors and actuators. IO-Link is based on point-to-point communication using a 3-wire IO-Link device connection without any additional requirements for the cable material. IO-Link is therefore not a fieldbus and is thus fieldbus-independent. The explanations above can be referred to for further details on IO-Link.

The coupler described above offers a number of advantages. One of these advantages is the facility to provide special functions (such as a switchover of operating modes, which are to be defined or are defined, of at least one IO-Link device, here the coupler) by means of IO-Link communication, which cannot be mapped by the IO-Link standard. In addition, the coupler has the advantage that it can be switched to a (password-) protected mode. It is conceivable that the predetermined control command is not stored in a public IODD (see above for details of the IODD), so that the control command, which can be stored in the device data e.g. as a string, can be used as a password to switch to the protected (operating) mode.

The device data can be communicated acyclically in accordance with the predetermined communications standard, triggered by the master.

More precisely, three different types of data are exchanged or transmitted in accordance with the IO-Link protocol of the IO-Link (communications) standard, i.e. process data, device parameters and so-called events (comprising the three categories of errors, warnings and notifications). Process data are transmitted cyclically. Device parameters or general device data and events are transmitted acyclically. The IO-Link device or slave transmits data only or exclusively if it is requested to do so by the IO-Link master. Process data are transmitted cyclically with each frame. Device parameter data are explicitly requested by the master, i.e. a transmission of device data is triggered by the master.

The coupler can be designed to perform the called function, so that the coupler switches from a current operating mode to a further operating mode, and optionally switches back again if a predetermined condition occurs.

It is consequently not necessary to adjust or operate the coupler additionally in order to control the coupler. Instead, the coupler can be controlled directly by means of the transmitted control command using the underlying communications standard, and therefore in the field.

The current and/or the further operating mode can be a transmit mode, in which the coupler is designed to output data received from the master in accordance with the predetermined communications standard to the slave in accordance with the predetermined communications standard, a configuration mode, in which the coupler is designed to be parameterized, and/or a protected operating mode, in which the coupler is designed to be parameterized to a degree extending beyond the configuration mode.

It is conceivable, for example, that the current operating mode (i.e. the operating mode to which the coupler is set at the time of receiving the control command) is the transmit mode, and the coupler switches to configuration mode due to the function.

In transmit mode, the data can be transmitted (optionally bi-directionally) via the coupler from the master to the slave. In configuration mode, the data transmission between the master and the slave can be stopped until the parameterization of the coupler has been completed. It is then conceivable that the coupler automatically switches back to transmit mode or that a (further) predetermined control command is output to the coupler so that the coupler switches (back) to transmit mode.

Additionally or alternatively, it is possible, for example, that the current operating mode is the transmit mode, and the coupler switches to the protected operating mode due to the function. Device settings and/or characteristics of the coupler, for example, which are modifiable only or exclusively in the protected operating mode can then be read out and/or modified in the protected operating mode. It is then conceivable that the coupler automatically switches back to transmit mode or that a (further) predetermined control command is output to the coupler so that the coupler switches (back) to transmit mode.

Additionally or alternatively, it is conceivable, for example, that the current operating mode is the transmit mode, and the coupler switches to the configuration mode due to a function called by a first control command. As soon as the coupler is set to the configuration mode, it is conceivable that the coupler switches to the protected operating mode due to a function called by a second control command. This can be referred to as a two-stage method, wherein the second control command acts as a password to switch from the configuration mode to the protected operating mode.

The device data can comprise a service data unit in accordance with a predetermined communications protocol, optionally the IO-Link protocol, of the predetermined communications standard, said service data unit having an area in which a plurality of standard parameters are storable in accordance with the predetermined communications protocol. The control command can be stored in this area.

More precisely, parameter data are explicitly requested by the IO-Link master in accordance with the IO-Link protocol of the IO-Link (communications) standard or are transmitted flagged as such. A service data unit, known as an ISDU (indexed service data unit), is defined in the IO-Link specification for this purpose. Parameter values and states can be queried and parameters can be stored in the IO-Link device using indices and subindices. The requests (read-write services) are encoded in the IO-Link master into an IO-Link-specific ISDU and are transmitted via the IO-Link interface to the IO-Link device. The ISDU specifies whether the request is a read or write request. The indices specify the parameters of which the values are to be read or written. It is now proposed to use this ISDU optionally to transmit the control command from the master to the coupler.

Up to 65536 indices of up to 232 bytes in size can be addressed via IO-Link. The IO-Link specification already contains predefined indices (predefined parameters). The IO-Link devices can be uniquely identified by means of these indices. However, most of the defined indices are optional, i.e. they can be used but are not mandatory. The advantage of using the indices that have already been defined and have been implemented as mandatory for transmitting the control command is that they are available in every IO-Link device (as from a specific version).

In the area of the service data unit, in which a plurality of standard parameters are storable in accordance with the predetermined communications protocol, a first sub-area can be provided for an application-specific tag, a second sub-area can be provided for a location tag and/or a third sub-area can be provided for a function tag in accordance with the predetermined communications protocol. The control command can be stored in at least one of these sub-areas.

This has the advantage that these sub-areas are large enough to transmit a control command.

The coupler can be designed to output information to the master in response to the detected control command.

It is conceivable for the above-mentioned events, in particular the notification sub-category, to be used in accordance with the IO-Link protocol.

The coupler can be designed to receive process data from the master in accordance with the predetermined communications standard and to output these data to the slave in accordance with the predetermined communications standard. The process data can be communicated cyclically in accordance with the predefined communications standard.

The coupler can be designed to receive further process data and/or further device data from the slave in accordance with a predetermined communications standard and to output these data to the master in accordance with the predetermined communications standard. The further process data can optionally be communicated cyclically in accordance with the predefined communications standard. The further device data can be communicated in accordance with the predetermined communications standard, triggered by the master, optionally by means of an additional service data unit and/or acyclically.

The coupler can have an inductive coupler or can be configured as such. An inductive coupler can be understood to mean a transformer in which the transformer core is divisible, i.e. both parts can be separated from each other. The primary winding is positioned on one part of the core and the secondary winding is positioned on the other part of the core. In addition to the transmission of data, the inductive coupler allows the transmission of electrical energy from the master to the slave.

The above description can be summarized in other words and with reference to a specific embodiment as described below, wherein this following description is given only by way of example and is therefore not limiting for the disclosure.

IO-Link standard parameters (mandatory parameters in accordance with the IO-Link specification in the ISDU area) can be used to control exclusive device functions. This means that commands can be sent to the address of a selected default parameter. The commands cannot be used to change the contents of the parameter, but to trigger an action or function. The command sets that are used can be defined in advance for this purpose. It is conceivable that they are not outwardly visible. It is very unlikely that an error will occur at this point, since the commands can be selected such that they do not collide with standard commands or contents.

It is also possible that password access can be implemented with the described solution. In addition to triggering an action, there may further be the option of returning responses (answers to the command). Reading can be performed in the subsequent ISDU frame or within a given period of time, optionally less than 10s after receiving the command. This function can be particularly useful in development and testing, as it allows an extended fault diagnosis by the manufacturer. Specifically, a type of command line interface can be implemented here which allows a command to be sent in the manner described above and the answer/response to the sent command to be read out. The use of ISDU area parameters which have a corresponding size and are available in all devices as from a specific version can be advantageous. The use of the parameters of the so-called application-specific tag, the location tag or the function tag can be particularly suitable for this purpose. The commands can be used to switch the operating modes of infrastructure components. Infrastructure components of this type, such as inductive couplers, offer not only the transmission of supply power from connected devices, but also IO-Link communication (loop-through between master-coupler-device) with the connected device. In addition to this transmit mode, there can be another operating mode for configuring the coupler itself, known as the configuration mode, since this cannot be possible in transmit mode due to the active communication. The solution proposed here allows these two modes to be switched by sending a command, for example, to the address of the application-specific tag. The coupler can then be configured and optionally reset to transmit mode. As a further stage, if the coupler is in configuration mode, it can be provided to switch to a protected operating mode or administrator mode. For this purpose, a further command can be sent to the coupler in the manner described above, wherein the command comprises a password which, for example, is sent in turn as a string to the address of the application-specific tag (or another of the above-mentioned tags). The password can comprise a switchover of the coupler from configuration mode to administrator mode, wherein parameters or settings of the coupler can be modifiable and/or readable in administrator mode, but cannot be accessed in configuration mode.

The disclosure further relates to a communications network. The communications network has a master, a coupler, optionally the coupler described above, and a slave connected via the coupler to the master. The coupler is designed to receive device data from the master in accordance with a predetermined communications standard (and optionally to output these data to the slave in accordance with the predetermined communications standard). The coupler is designed to recognize a predetermined control command in the device data and to call a function stored in the coupler according to the detected control command.

The master can be designed to generate the device data, optionally in the manner described above, comprising the predetermined control command, and to output these device data to the coupler.

The communications network can have a control and management system which is connected to the slave via the master and the coupler. It is conceivable that the control and management system communicates with the master in accordance with a further predetermined communications standard (e.g. PROFIBUS, PROFINET, INTERBUS, AS-i, EtherCAT, Ethernet, or Powerlink).

The description above relating to the coupler also applies accordingly to the communications network, and vice versa.

The disclosure further relates to a method for operating a coupler, optionally the coupler described above, for connecting a master to a slave of a communications network, wherein the method comprises receiving device data from the master to the coupler in accordance with a predetermined communications standard (and optionally outputting the received device data from the coupler to the slave in accordance with the predetermined communications standard). The method comprises detecting a predetermined control command in the device data by use of the coupler and calling a function stored in the coupler according to the detected control command by means of the coupler.

The method can be a computer-implemented method, i.e. one, a plurality or all steps of the method can be carried out at least partially by a computer or a data processing device.

The description above relating to the coupler and to the communications network also applies accordingly to the method, and vice versa.

A computer program and/or computer-readable medium are further provided, comprising commands which, when the program or commands are executed by a coupler, optionally the coupler described above, for connecting a master to a slave of a communications network, cause the coupler to carry out, at least partially, the method described above.

The computer program can be firmware of the coupler. Firmware can be understood to mean software which is (permanently) embedded in electronic devices, such as the coupler here, and performs basic functions there. The firmware can take up an intermediate position between the hardware of the coupler (i.e. the physical components of the coupler) and any existing application software (known as the function). The firmware can be stored in a memory of the coupler. The memory can be a flash memory, EPROM, EEPROM, or ROM. The computer program can further comprise the function described above.

The computer-readable medium can have the computer program described above.

The computer-readable medium can be a computer-readable storage medium, i.e. any digital data storage device, such as a USB stick, a hard disk, a flash memory, a CD-ROM, an SD card or an SSD card.

The computer program or commands do not necessarily have to be stored on such a computer-readable storage medium in order to be made available to the coupler, but can also be obtained via the Internet or from some other external source.

The description above relating to the coupler, the communications network and the method also applies accordingly to the computer program and/or the computer-readable medium, and vice versa.

It should also be noted that, unless otherwise defined, all technical and scientific terms used herein have the same meaning as generally understood by a person skilled in the art to which this disclosure relates. If a plurality of definitions exist for a term, the definitions in this description will take precedence, unless otherwise indicated.

Wherever the expressions “for example”, “such as”, “including” and the like are used, they shall be construed as if they were followed by the term “and without limitation”, unless expressly indicated otherwise. Similarly, the terms “an example”, “by way of example”, and the like are to be understood as non-limiting or as a non-exhaustive listing.

Indications of numbers are to be understood as both final and non-final, i.e., for example, “a/one slave” is to be understood as” at least one slave and/or exactly one slave “.

The term “substantially” allows for deviations that do not adversely affect the intended purpose. Descriptive terms are to be understood as being modified by the term “substantially”, even if the term “substantially” is not explicitly mentioned.

The terms “comprising” and “including” and “having” and “incorporating” (and similarly
comprises”, “includes”, “has” and “incorporates”) and the like are used synonymously and have equal significance.

Consequently, unless the context clearly or explicitly requires otherwise, the words “comprise”, “comprising” and the like in the description and in the claims are to be understood in an inclusive sense and not in an exclusive or exhaustive sense, i.e., in the sense of” including but not limited to”.

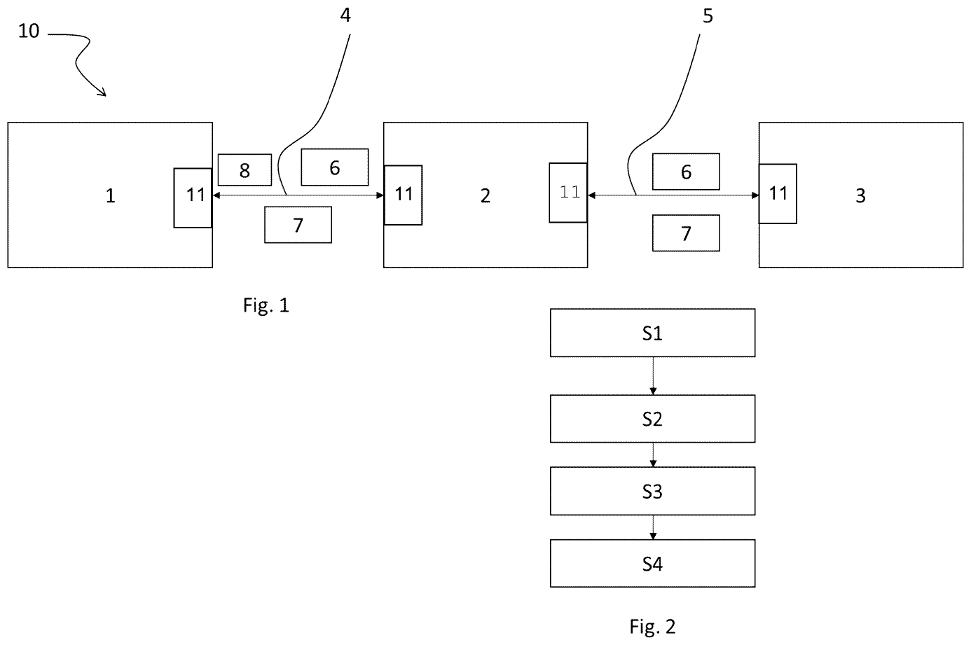

The communications network 10 shown in FIG. 1 has a master 1, a coupler 2 and a slave 3 connected via the coupler 2 and two data lines 4, 5 to the master 1. Bi-directional (data) communication takes place in accordance with the IO-Link standard between the master 1 and the slave 3 via the coupler 2 and the two data lines 4, 5. The coupler 2 is therefore designed to receive data from the master 1 in accordance with the IO-Link standard and to forward the data to the slave 3 in accordance with the IO-Link standard, and to receive data from the slave 3 in accordance with the IO-Link standard and to forward the data to the master 1 in accordance with the IO-Link standard. Any data exchange or (data) communication mentioned below is compliant with the IO-Link standard. A higher-level control and management system, which is not shown, can be connected to the master 1, said system serving to control and monitor a process in which the slave 3 configured as a field device is used.

Each of the master 1, the coupler 2, and the slave 3 include one or more communication interfaces 11 for receiving and/or outputting data from/to the communications network. The communication interfaces may be digital and/or analog communication interfaces.

In the embodiment, the communications network 10 is operated according to the method as disclosed for operating the communications network 10, the flow diagram of which is shown schematically in FIG. 2, and which is explained in detail below.

In a first step S1 of the method, process data 6 are exchanged cyclically via the coupler 2 and the data lines 4, 5 between the master 1 and the slave 3. During the first step S1, device data 7 in the form of service data units are exchanged repeatedly and acyclically in accordance with the IO-Link protocol, triggered by the master 1, via the coupler 2 and the data lines 4, 5 between the master 1 and the slave 3 in order to parameterize the slave 3.

From the perspective of the master 1, the process data can comprise input data, the values measured by the slave 3 (such as e.g. temperature, distance, volume, rotational speed, flow rate, etc.), and/or output data, comprising control data (e.g. rotational speed, pressure or pressure difference, lamp on/off, light color, blinking pattern, output voltage, output current) for the slave 3 (e.g. to control actuators, such as e.g. motors, valves, signal lights, power supply units, by means of the slave 3).

The coupler 2 forwards these device data 7, intended for the slave 3 or for the master 1, essentially without modification, i.e. the coupler 2 loops through these device data 7 as well as the process data 6. The coupler 2 is therefore set to a transmit mode. However, the coupler 2 does not loop through the service data unit of the device data 7 if it contains a predetermined control command.

In order to determine this, in a second step S2 of the method running parallel or simultaneously with the first step S1, the coupler 2 checks the service data units of the device data 7 received from the master 1 to determine whether they contain the predetermined control command.

More precisely, the service data units of the device data 7 comprise an area in which a plurality of standard parameters are storable in accordance with the IO-Link protocol, wherein the master 1 stores the predetermined control command in this area. It is conceivable that the master 1 stores the predetermined control command as a string in the sub-area provided for the so-called application-specific tag, the so-called location tag and/or the so-called function tag. The coupler 2 therefore checks these sub-areas to see whether the predetermined control command is contained in one of them.

If the control command is detected by the coupler 2 in the second step S2, the coupler 2 outputs information 8 to the master 1 via the data line 4 in response to the detected control command, and the method continues with a third step S3. Otherwise, the first and second steps S1, S2 will continue to be carried out. The information can be an acknowledgment of receipt of the control command and a termination of the connection or a suspension of the loop-through of process data so that the connection to the master 1 can then be re-established in configuration mode (see steps S3 and S4).

In the third step S3 of the method, the coupler 2 calls a function stored in the coupler 2 depending on the control command detected in the device data 7. A plurality of functions can be stored in the coupler 2, wherein the control command is then designed such that the coupler 2 can uniquely assign the control command to at least one of these functions.

In a fourth step S4 of the method, the coupler 2 performs the called function. The function can be a function that switches the coupler 2 from the current operating mode to a further or different operating mode defined in the function. This can be, for example, a configuration mode, in which the coupler 2 can be parameterized by means of the master 1, and/or a protected operating mode or admin mode, for which the control command acts as a password. The admin mode can be activated in the coupler 2, in particular within the configuration mode, in order to gain access to further IO-Link indices that are not available in configuration mode. This means that the coupler can be parameterized in admin mode to a degree that extends beyond configuration mode. This can be used for extended fault diagnostics or for manufacturer parameterization. In order to switch from configuration mode to admin mode, the third and fourth steps S3, S4 of the method can be carried out repeatedly as soon as the coupler 2 is set to configuration mode.

### LIST OF REFERENCE CHARACTERS

1 Master
2 Coupler
3 Slave
5 4 Data line between master and coupler
5 Data line between slave and coupler
6 Process data
7 Device data
8 Information in response to control command
10 Communications network
S1-S4 Method steps

What is claimed is:

1. A coupler for connecting a master to a slave of a communications network, wherein the coupler comprises
a first communication interface and a second communication interface,
wherein the coupler is designed to receive device data from the master via the first communications interface in accordance predetermined communications standard, detect a predetermined control command in the device data, and call a function stored in the coupler according to the detected control command upon detection of the predetermined control command.

2. The coupler as claimed in claim 1, wherein the device data are communicated acyclically in accordance with the predetermined communications standard, triggered by the master.

3. The coupler as claimed in claim 1, wherein the coupler is designed to perform the called function so that the coupler switches from a current operating mode to a further operating mode due to the function.

4. The coupler as claimed in claim 3, wherein the current operating mode and/or the further operating mode comprise:
a transmit mode, in which the coupler is designed to output data received from the master in accordance with the predetermined communications standard via the second communication interface to the slave in accordance with the predetermined communications standard,
a configuration mode, in which the coupler is designed to be parameterized, and/or
a protected operating mode, in which the coupler is designed to be parameterized to a degree extending beyond configuration mode.

5. The coupler as claimed in claim 1, wherein:
the device data comprise a service data unit in accordance with a predetermined communications protocol of the predetermined communications standard, said service data unit including an area in which a plurality of standard parameters are storable in accordance with the predetermined communications protocol, and
the control command is stored in this area.

6. The coupler as claimed in claim 5, wherein:
in the area of the service data unit, in which a plurality of standard parameters are storable in accordance with the predetermined communications protocol, a first sub-area is provided for an application-specific tag, a second sub-area is provided for a location tag and/or a third sub-area is provided for a function tag in accordance with the predetermined communications protocol, and
the control command is stored in at least one of these sub-areas.

7. The coupler as claimed in claim 1, wherein the coupler is designed to output information to the master in response to the detected control command.

8. The coupler as claimed in claim 1, wherein:
the coupler is designed to receive process data from the master in accordance with the predetermined communications standard, and
the process data are optionally communicated cyclically in accordance with the predetermined communications standard.

9. The coupler as claimed in claim 1, wherein:
the coupler is designed to receive further process data and/or further device data from the slave via the second communication interface in accordance with a predetermined communications standard and to output these data to the master in accordance with the predetermined communications standard,
the further process data are optionally communicated cyclically in accordance with the predetermined communications standard, and
the further device data are communicated in accordance with the predetermined communications standard, triggered by the master, optionally by use of a further service data unit and/or acyclically.

10. The coupler as claimed in claim 1, wherein the coupler has an inductive coupler or is designed as such.

11. A communications network, comprising:
a master, a coupler and a slave connected via the coupler to the master,
wherein the coupler is designed to receive device data from the master in accordance with a predetermined communications standard, detect a predetermined control command in the device data, and call a function stored in the coupler according to the detected control command upon detection of the control command.

12. The communications network as claimed in claim 11, wherein the master is designed to generate the device data comprising the predetermined control command and to output these device data to the coupler.

13. The communications network as claimed in claim 11, wherein the coupler comprises a first communication interface and a second communication interface,
wherein the coupler is designed to:
receive device data from the master via the first communications interface in accordance with a predetermined communications standard,
detect a predetermined control command in the device data, and
call a function stored in the coupler according to the detected control command upon detection of the predetermined control command, and
wherein the device data are communicated acyclically in accordance with the predetermined communications standard, triggered by the master.

14. A method for operating a coupler for connecting a master to a slave of a communications network, wherein the method comprises:
receiving device data from the master to the coupler in accordance with a predetermined communications standard,
detecting a predetermined control command in the device data by use of the coupler, and
calling a function stored in the coupler according to the detected control command by use of the coupler upon detecting the predetermined control command in the device data.

15. A computer program and/or computer-readable medium comprising commands which, when the program or commands are executed by a coupler for connecting a master to a slave of a communications network, cause the coupler to carry out the method as claimed in claim 14.
